(19) United States
(12) Patent Application Publication
(10) Pub. No.: US 2022/0021215 A1
(43) Pub. Date: Jan. 20, 2022

(54) POWER TRANSMISSION METHOD AND SYSTEM

(71) Applicant: Ururaki Inc, Mississauga (CA)

(72) Inventors: Mahdi S. Atteia, Mississauga (CA); Drew A. Camilucci, Mississauga (CA); Mhamad Salih, Mississauga (CA)

(21) Appl. No.: 17/377,015

(22) Filed: Jul. 15, 2021

Related U.S. Application Data
(60) Provisional application No. 63/052,060, filed on Jul. 15, 2020.

(51) Int. Cl. H02J 3/36; H02J 3/38

(52) U.S. Cl. CPC H02J 3/36; H02J 2300/22; H02J 3/381

(57) ABSTRACT

A power transmission method comprises receiving direct current (DC) input from a generating station; boosting the voltage of the DC input to a higher transmission voltage; and transmitting the boosted DC over a medium voltage (MV) or high voltage (HV) DC transmission line to a destined load.

### CROSS-REFERENCE TO RELATED APPLICATION

This application claims the benefit of U.S. Provisional Application No. 63/052,060 filed on Jul. 15, 2020, the entire contents of which are incorporated herein by reference.

### FIELD

The subject disclosure relates to a power transmission method and system.

### BACKGROUND

The power generated by remote direct current (DC) power plants, power sources, or generating stations (hereinafter referred to as “generating stations”), such as solar power farms, has typically been low voltage and has largely been converted to alternating current (AC) for transmission from the DC generating stations to a destined load such as a power grid. Converting the power from DC to AC however, requires the construction of a substation near each DC generating station. These substations typically require multiple micro-inverters to convert the DC output of the DC generating station to AC, a large, custom designed transformer for stepping up the AC voltage to a level suitable for transmission over a high voltage alternating current (HVAC) transmission line, and a local static VAR compensator to regulate and control the power factor to keep the power factor close to unity.

As will be appreciated, employing substations of this nature has several disadvantages. For example, converting the low voltage DC to AC and then stepping up the AC voltage, complicates the process of power transmission by reducing efficiency and increasing implementation and maintenance costs. This is especially true when the DC generating stations are in remote, difficult to reach locations.

Another disadvantage in converting the DC output of the DC generating stations to AC is that the power transmission is restricted to low frequency. The electric power generation and distribution industry, largely still uses alternating current operating at low frequency (50 Hz to 60 Hz) and three-phase transformers as the only method to step up or step down the AC voltage. Unfortunately, three-phase transformers are extremely heavy, expensive, have high losses and need to be custom-made for each DC generating system.

For example, turning now to FIG. 1, a conventional power transmission system for boosting and transmitting DC power generated at a remote DC generating station, such as a solar power farm, to a destined load, such as a power grid, is shown and is generally identified by reference numeral 10. As can be seen, the power transmission system 10 comprises two primary sections; namely a DC link 12 and an AC link 14 electrically coupled to the DC link 12 by an array of micro-inverters 16. The DC link 12 is constituted solely by the remote DC generating station 20.

In this example, the remote DC generating station 20 is a solar power farm that comprises a plurality solar panel strings 22, with each solar panel string 22 comprising a plurality of solar panel arrays 24 connected in series. Although only three solar panel strings 22 are shown, those of skill in the art will appreciate that the DC generating station 20 may comprise fewer or more solar panel strings 22. Also, although each solar panel string 22 is shown as comprising three solar panel arrays 24, this is for ease of illustration only as each solar panel string 22 typically comprises more than twenty solar panel arrays 24. The DC output of each solar panel string 22 is typically about 600V to about 1200V.

Each solar panel string 22 is electrically connected to an associated micro-inverter 16 (or array of micro-inverters 16), which converts the DC output of the solar panel string 22 into AC for transmission over the AC link 14.

The AC outputs of the micro-inverters 16 are electrically connected in parallel to a common AC bus 30 via respective circuit breakers 32 and contactors 34. The circuit breakers 32 open automatically during unsafe conditions to electrically isolate individual solar panel strings 22 of the DC generating station 20 from the AC link 14. The contactors 34 can be controlled manually or automatically by a system controller (not shown) to electrically isolate individual solar panel strings 22 from the AC link 14.

The AC bus 30 is electrically connected to an AC input line 38 of a substation 40 via a circuit breaker 42 and contactor 44. The circuit breaker 42 opens automatically during unsafe conditions to electrically isolate the DC generating station 20 from the substation 40. The contactor 44 can be controlled manually or automatically by the system controller to isolate the DC generating station 20 from the substation 40.

A static VAR compensator 50 within the substation 40 is electrically connected between the AC input line 38 and ground G and is configured to filter harmonics, regulate the output voltage, and control the power factor to keep the power factor close to unity. As can be seen, the static VAR compensator 50 comprises a bank of switched shunt capacitors and reactors.

The AC input line 38 is electrically connected to the primary side 52a of a three-phase boost transformer 52 within the substation 40 that steps up the AC voltage on the AC input line 38 to the required high AC transmission voltage, typically between about 33 kV to about 230 kV. The secondary side 52b of the transformer 52 is electrically connected to a HVAC transmission line 60 via a high voltage circuit breaker 62. The high voltage circuit breaker 62 opens automatically during unsafe conditions to electrically isolate the substation 40 from the HVAC transmission line 60.

The high voltage AC transmission line 60 is also electrically connected to the primary side 66a of a step down transformer 66 of another substation 70 via a high voltage circuit breaker 72. The high voltage circuit breaker 72 opens automatically during unsafe conditions to electrically isolate the substation 70 from the HVAC transmission line 60. The step down transformer 66 steps down the high AC voltage to the level of the power grid to which the AC voltage is to be applied, typically about 11 kV. The secondary side 66b of the step down transformer 66 is electrically connected to an AC output line 74. A static VAR compensator 76 within the substation 70 is electrically connected to the AC output line 74 and to ground G and is configured to filter harmonics, regulate the output voltage, and control the power factor to keep the power factor close to unity. The static VAR compensator 76 comprises a bank of switched shunt capacitors and reactors. The AC output line 74 is electrically connected to the substation output 77 via a circuit breaker 78 and a contactor 80. The circuit breaker 78 opens automatically during unsafe conditions to electrically isolate the substation 70 from the power grid. The contactor 80 can be controlled manually or automatically by a system controller to electrically isolate the substation 70 from the power grid.

The substation output 77 is electrically connected to a bus 82, which is electrically connected in parallel to a plurality of transmission lines 84 leading to the power grid via respective circuit breakers 88 and contactors 90. The circuit breakers 88 open automatically during unsafe conditions to electrically isolate the substation 70 from individual transmission lines 84. The contactors 90 can be controlled manually or automatically by the system controller to electrically isolate the substation 70 from individual transmission lines 84.

As will be appreciated, the power transmission system 10 suffers the disadvantages discussed above in that the DC power generated at the DC generating station 20 needs to be converted to AC and stepped up at a local substation 40 using a three-phase transformer 52 in order to be transmitted over the HVAC transmission line 60 to a destined load.

As will be appreciated, improvements in power transmission are desired. It is therefore an object to provide a novel power transmission method and system.

This background serves only to set a scene to allow a person skilled in the art to better appreciate the following description. None of the above discussion should necessarily be taken as an acknowledgement that this discussion is part of the state of the art or is common general knowledge.

### BRIEF DESCRIPTION

It should be appreciated that this brief description is provided to introduce a selection of concepts in a simplified form that are further described below in the detailed description. This brief description is not intended to be used to limit the scope of the claimed subject matter.

Accordingly, in one aspect there is provided a power transmission method comprising: receiving direct current (DC) input from a generating station; boosting the voltage of the DC input to a higher transmission voltage; and transmitting the boosted DC over a medium voltage (MV) or high voltage (HV) DC transmission line to a destined load.

In one or more embodiments, the method further comprises, after transmission over the DC transmission line, converting the boosted DC to alternating current (AC) output for feeding to the destined load.

In one or more embodiments, the generating station is a solar power farm and the DC input is in the range of about 600V to about 1200V.

In one or more embodiments, the DC input is boosted to a voltage in the range of about 33 kV to about 230 kV.

In one or more embodiments, the DC input is received from one of a solar power farm, a battery energy storage system, a hydrogen fuel cell plant, one or more DC generators, and one or more magnetohydrodynamic generators.

In one or more embodiments, the boosting is performed by a DC to DC boost converter or an array of DC to DC boost converters. In one form, boosting comprises: converting the DC input to alternating current (AC) output; stepping up the AC output; and rectifying the stepped-up AC output to generate the boosted DC.

According to another aspect there is provided a power transmission system comprising: at least one DC to DC boost converter configured to receive and boost a DC input received from a DC generating station; and an MVDC or HVDC transmission line electrically connected to the at least one DC to DC boost converter and configured to transmit the boosted DC input to a destined load.

In one or more embodiments, the power transmission system may comprise a plurality of DC to DC boost converters, each receiving a DC input from the DC generating station and providing boosted DC input to the transmission line.

In one form, the plurality of DC to DC converters may comprise one of (i) DC to DC converters connected electrically in parallel, (ii) DC to DC converters electrically connected in series, and (iii) DC to DC converters electrically connected in parallel and in series.

In one or more embodiments, the DC generating station is a solar power farm and each DC to DC converter is configured to receive DC input from one or more respective solar panel strings of the solar power farm.

In one or more embodiments, the DC input is in the range of about 600V to about 1200V.

In one or more embodiments, the DC input is boosted to a voltage in the range of about 33 kV to about 230 kV.

### BRIEF DESCRIPTION OF DRAWINGS

Embodiments will now be described more fully with reference to the accompanying drawings, in which like reference numerals will be used to identify like components, and in which:

FIG. 1 is a schematic of a conventional power transmission system;

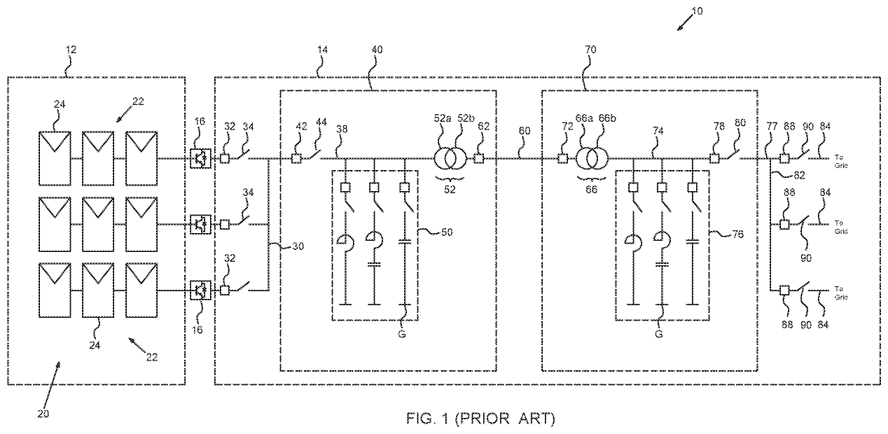

FIG. 2 is a schematic of a power transmission system in accordance with the subject disclosure;

FIG. 3 is a schematic of an exemplary DC to DC boost converter forming part of the power transmission system of FIG. 2; and

FIG. 4 is a schematic of an alternative DC to DC boost converter.

### DETAILED DESCRIPTION

The foregoing brief description, as well as the following detailed description of certain examples will be better understood when read in conjunction with the accompanying drawings. As used herein, a feature, structure, element, component etc. introduced in the singular and preceded by the word “a” or “an” should be understood as not necessarily excluding the plural of the features, structures, elements, components etc. Further, references to “one example” or “one embodiment” are not intended to be interpreted as excluding the existence of additional examples or embodiments that also incorporate the described features, structures, elements, components etc. Reference herein to “example” means that one or more feature, structure, element, component, characteristic and/or operational step described in connection with the example is included in at least one embodiment and/or implementation of the subject matter according to the subject disclosure. Thus, the phrases “an example,” “another example,” and similar language throughout the subject disclosure may, but do not necessarily, refer to the same example. Further, the subject matter characterizing any one example may, but does not necessarily, include the subject matter characterizing any other example.

As used herein, the term “and/or” can include any and all combinations of one or more of the listed features, structures, elements, components or other subject matter.

Unless explicitly stated to the contrary, examples or embodiments “comprising” or “having” or “including” a feature, structure, element, component or other subject matter or a plurality of features, structures, elements, components or other subject matter having a particular property may include additional features, structures, elements, components or other subject matter not having that property. Also, it will be appreciated that the terms “comprises”, “has”, “includes” means “including but not limited to” and the terms “comprising”, “having” and “including” have equivalent meanings.

Reference herein to “configured” denotes an actual state of configuration that fundamentally ties the element or feature to the physical characteristics of the feature, structure, element, component or other subject matter preceding the phrase “configured to.” Thus, “configured” means that the feature, structure, element, component or other subject matter is designed and/or intended to perform a given function. Thus, the use of the term “configured” should not be construed to mean that a given feature, structure, element, component or other subject matter is simply capable of performing a given function but that the feature, structure, element, component or other subject matter is specifically selected, created, implemented, utilized, and/or designed for the purpose of performing the function.

It will be understood that when a feature, structure, element, component or other subject matter is referred to as being “connected” to another feature, structure, element, component or other subject matter, that feature, structure, element, component or other subject matter can be directly connected to the other feature, structure, element, component or other subject matter or intervening features, structures, elements, components or other subject matter may also be present. In contrast, when a feature, structure, element, component or other subject matter is referred to as being “directly connected” to another feature, structure, element, component or other subject matter, there are no intervening features, structures, elements, components or other subject matter present.

As used herein, the terms “approximately” and “about” represent an amount or condition close to the stated amount that results in the desired function being performed or the desired result being achieved. For example, the terms “approximately” and “about” may refer to an amount or condition that is within engineering tolerances to the precise value or condition specified that would be readily appreciated by a person skilled in the art.

In the following description, reference is made to low-voltage, medium voltage and high voltage. For reference and as will be adopted in the subject application, the American National Standards Institute (ANSI) classifies voltages below 600V as low-voltage, voltages between 600V to 69 kV as medium voltage, and voltages between 69 kV to 230 kV as high voltage.

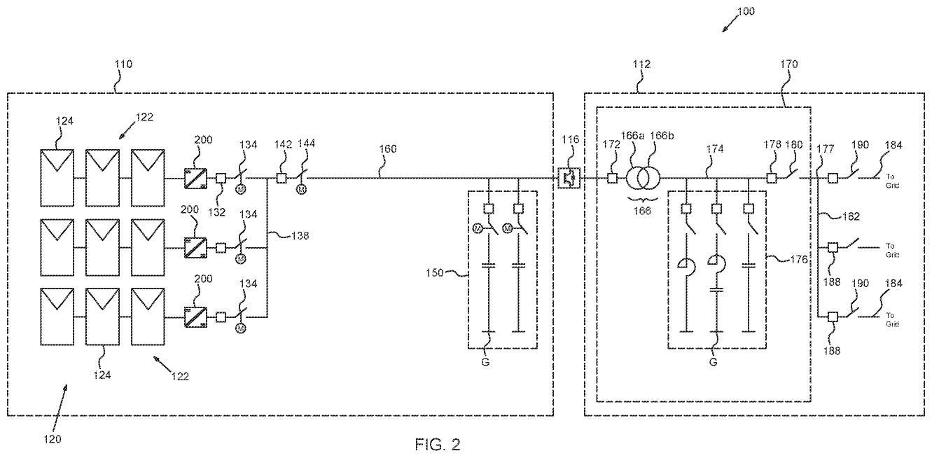

In the following a power transmission system and method are described and illustrated. In general, direct current (DC) input is received from a generating station, such as a solar power farm or other low voltage DC source. The voltage of the DC input is boosted to a higher transmission voltage using, for example, one or more DC to DC boost converters. The boosted DC is then transmitted to a destined load over a medium voltage direct current (MVDC) or high voltage direct current (HVDC) transmission line. Further specifics of the subject power transmission method and system will now be described with particular reference to FIG. 2.

Turning now to FIG. 2, a power transmission system for boosting and transmitting DC power generated at a remote DC generating station, such as a solar power farm, to a destined load, such as a power grid, is shown and is generally identified by reference numeral 100. As can be seen, the power transmission system 100 comprises two primary sections; namely a DC link 110 and an AC link 112 electrically coupled to the DC link 110 by a micro-inverter 116 or array of micro-inverters 116. The DC link 110 comprises the remote DC generation system 120 at one terminal end thereof. In this example, the remote DC generating station 120 is a solar power farm that comprises a plurality solar panel strings 122, with each solar panel string 122 comprising a plurality of solar panel arrays 124 connected in series. Although only three solar panel strings 122 are shown, those of skill in the art will appreciate that the DC generating station 120 may comprise fewer or more solar panel strings 122. Also, although each solar panel string 122 is shown as comprising three solar panel arrays, this is for ease of illustration only as each solar panel string 122 typically comprises more than twenty (20) solar panel arrays 124. The DC output of each solar panel string 122 is typically about 600V to about 1200V.

Each solar panel string 122 is electrically connected to a DC to DC boost converter 200 or array of DC to DC boost converters 200. Each DC to DC boost converter 200 is configured to boost the DC input received from its associated solar panel string 122 to DC output at the required medium transmission voltage or high transmission voltage, typically about 33 kV to about 230 kV.

The medium voltage or high voltage DC outputs of the DC to DC boost converters 200 are electrically connected in parallel to DC output rails 138 via respective circuit breakers 132 and motorized contactors 134. The circuit breakers 132 open automatically during unsafe conditions to electrically isolate individual solar panel strings 122 of the DC generating station 120. The motorized contactors 134 are automatically controlled by a system controller (not shown) to electrically isolate individual solar panel strings 122 of the DC generating station 120. The DC output rails 138 are electrically connected to a MVDC or HVDC transmission line 160 via a circuit breaker 142 and motorized contactor 144. The circuit breaker 142 opens automatically during unsafe conditions to electrically isolate the DC generating station 120 from the DC transmission line 160. The motorized contactor 144 is controlled by the system controller to electrically isolate the DC generating station 120 from the DC transmission line 160.

The DC transmission line 160 is also electrically connected to the micro-inverter 116 or array of micro-inverters 116 at the other terminal end of the DC link 112. A switched capacitor bank 150 adjacent the terminal end of the DC link 112 is electrically coupled between the DC transmission line 160 and ground G. The switched capacitor bank 150 is configured to improve power quality by filtering harmonics, regulating voltage and providing the necessary capacity to overcome any instantaneous load fluctuations.

The high voltage AC output of the micro-inverter 116 or array of micro-inverters 116 is applied to the AC link 114, which in this embodiment comprises an AC substation 170. As can be seen, the substation 170 comprises a step down transformer 166. The primary side 166a of the step down transformer 166 is electrically connected to the micro-inverter 116 or array of micro-inverters 116 via a high voltage circuit breaker 172. The high voltage circuit breaker 172 opens during unsafe conditions to electrically isolate the substation 172 from the DC transmission line 160. The step down transformer 166 steps down the high AC voltage to the level of the power grid to which the AC voltage is to be applied, typically about 11 kV. The secondary side 166b of the step down transformer 166 is electrically connected to an AC line 174. A static VAR compensator 176 within the substation 170 is electrically connected to the AC line 174 and to ground G and is configured to filter harmonics, regulate the output voltage, and control the power factor to keep the power factor close to unity. The static VAR compensator 176 comprises a bank of switched shunt capacitors and reactors. The AC line 174 is electrically connected to the substation output 177 via a circuit breaker 178 and a contactor 180. The circuit breaker 178 opens automatically during unsafe conditions to electrically isolate the substation 170 from the power grid. The contactor 180 can be controlled manually or automatically by a system controller to electrically isolate the substation 170 from the power grid.

The substation output 177 is electrically connected to a bus 182, which is electrically connected in parallel to a plurality of transmission lines 184 leading to the power grid via respective circuit breakers 188 and contactors 190. The circuit breakers 188 open automatically during unsafe conditions to electrically isolate the substation 70 from individual transmission lines 184. The contactor 180 can be controlled manually or automatically by the system controller to electrically isolate the substation 170 from individual transmission lines 184.

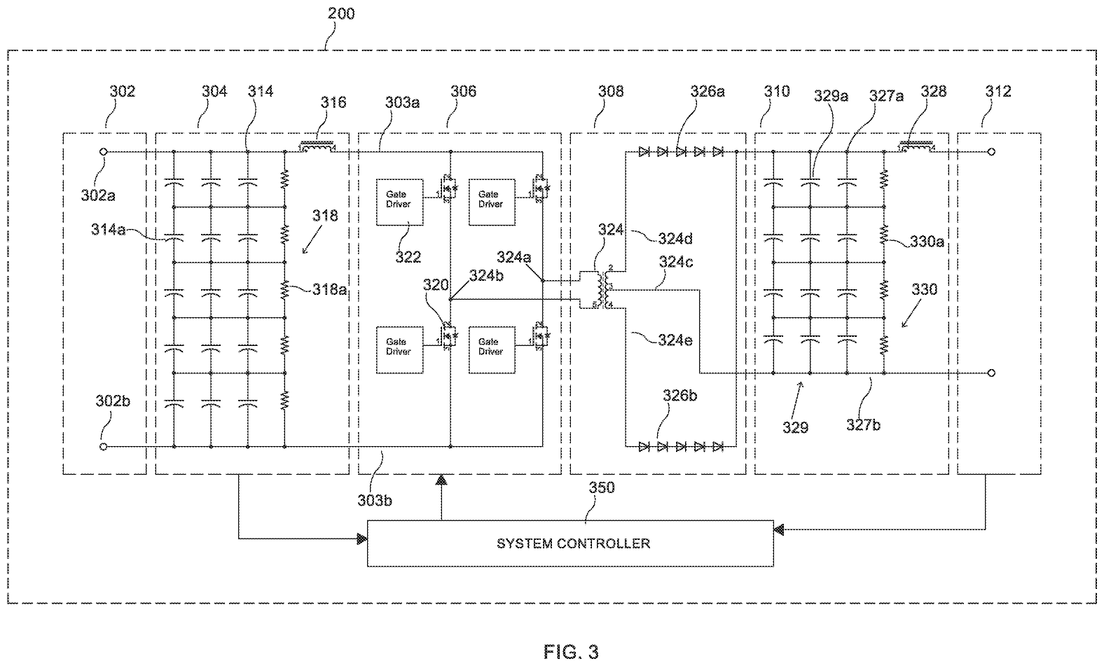

Turning now to FIG. 3, an exemplary DC to DC boost converter 200 is shown. As can be seen, the DC to DC boost converter 200 comprises an input unit 302 configured to receive DC input from the associated solar panel string 122, an input filter unit 304 configured to filter and stabilize the DC input, a bridge converter unit 306 configured to convert the stabilized DC input to an alternating current (AC) sinusoidal wave, a transformer-rectifier unit 308 to step up the AC sinusoidal wave and to convert the stepped up AC sinusoidal wave to pulsating medium voltage or high voltage DC output, an output filter unit 310 configured to filter and smooth the pulsating medium voltage or high voltage DC output, and an output unit 312 configured to output the resultant medium voltage or high voltage DC to the DC output rails 138 via the circuit breaker 132 and motorized contactor 134. A system controller 350 is communicatively coupled to the input filter unit 304, the bridge converter unit 306 and the output unit 312. In this embodiment, the DC to DC boost converter 200 boosts the DC input to a level in the range of about 33 kV to about 230 kV. The DC to DC boost converter 200 also has a power input range between about 50 kW and about 200 kW.

The input section 302 of the DC to DC boost converter 200 comprises a pair of input terminals 302a and 302b at the terminal ends of input DC rails 303a and 303b. The input terminals 302a and 302b are configured to be readily connected to the associated solar panel string 122 in order to receive the DC input to be boosted.

The input filter unit 304 comprises a capacitor bank 314 electrically connected across the input DC rails 303a and 303b, a resistor array 318 that is electrically connected across the input DC rails 303a and 303b in parallel with the capacitor bank 318, and an inductor array 316 electrically in series with the input DC rail 303a. Although the capacitor bank 314 is shown as comprising a 5×3 array of capacitors 314a and the resistor array 318 is shown as comprising five resistors 318a in series, this is for ease of illustration only. As will be appreciated by those of skill in the art, the capacitor bank 314 and the resistor array 318 will typically include significantly more capacitors 314a and resistors 318a than shown. The number of capacitors 314a and resistors 318a that are employed is determined, for example, by the type(s) of capacitors selected (polypropylene film, ceramic etc.), and the anticipated DC input voltage, DC input power, and DC input power stability. Likewise, although the inductor array 316 is shown as comprising a single inductor, this again is for ease of illustration only. As will be appreciated by those of ordinary skill in the art, the inductor array 316 will typically include more inductors.

The input filter unit 304 is configured to attenuate (or reduce) electromagnetic interference (EMI) and stabilize the DC input. The input filter unit 314 is further configured to provide the necessary capacity to handle instantaneous load fluctuations. The resistors 318a of the resistor array 118 serve as voltage dividers to ensure that the total voltage is equally distributed across each capacitor 314a, and as bleeder resistors to discharge electric charge stored in the capacitors 314a of the capacitor bank 314 when the DC to DC boost converter 200 is not in use, thereby reducing the risk of leftover charge, which may pose a potential shock hazard.

In this embodiment, the bridge converter unit 306 comprises four (4) discrete power transistors 320 arranged in an H-bridge configuration connected across the DC rails 303a and 303b. The power transistors 320 are operable in either a hard-switch or soft-switch mode to deliver power efficiently. While only four (4) power transistors 320 are shown to create the H-bridge, those of skill in the art will appreciate that this is for the purpose of simplifying the illustration. As is known, it is common industry practice to use multiple transistors in parallel to achieve higher efficiencies in power electronic applications and a comparable practice is employed in the subject DC to DC boost converter 300.

A gate driver 322 is associated with each power transistor 320. The gate drivers 322 respond to input signals from the system controller 350 and provide gate control signals to their associated power transistor 320 to enable the power transistor to perform its switching function all while maintaining adequate voltage isolation between the system controller 350 and the bridge converter unit 306.

The power transistors 320 exhibit a number of characteristics that make them particularly suited for use in the DC to DC boost converter 300. In particular, in this embodiment the power transistors 320 exhibit low switching losses at high switching frequencies to limit energy loss in the form of heat, a high drain to source voltage limit, a low drain to source on-resistance and a small total transition time per switching cycle (Tᵣᵢₛₑ+T_{fall}). For example, when operating at a switching frequency of at least 100 kHz, a forward current of about 50 A and a gate (switching) voltage of about 15V or higher, power transistors 320 having one or more of the following characteristics are employed: (i) switching losses below about 1 kW, (ii) total transition times per cycle of less than about one-hundred (100) nanoseconds, (iii) forwarded losses of about 80 W or less, and (iv) an on-resistance of about 0.03 ohms or less. Silicon Carbide (SiC) metal oxide semiconductor field effect transistors (MOSFETs) are suitable power transistors although those of skill in the art will appreciate that alternative power transistors having similar or better (lower switching losses and shorter total transition times) operating characteristics can be used.

The transformer-rectifier unit 308 comprises a high frequency boost transformer array 324 and a rectifier. The terminals 324a and 324b on the primary side of the boost transformer array 324 are connected to the H-bridge, with each terminal 324a, 324b being connected a different leg of the H-bridge between a pair of the power transistors 320. The boost transformer array 324 has a negative tap 324c, which functions as the common.

In this embodiment, the boost transformer array 324 is selected to accommodate about 50 kW total boost power. Rather than employing a single larger transformer rated for about 50 kW, a plurality of smaller transformers combined in parallel, in this case four (4) transformers, are employed. This allows the total core volume that is needed for higher power capacity to be achieved while maintaining winding length so as to avoid increased winding resistance and while maintaining core surface area for natural cooling. The parallel transformers also allow the current in each transformer to be reduced thereby to reduce copper losses. The primary and secondary windings of each transformer comprise a printed circuit board (PCB) stack through which the transformer core passes. Each printed circuit board comprises a thin copper coil, having a high surface area to volume that allows the skin effect resulting from operating at a high frequency to be taken advantage of, disposed on opposite sides of an electrically insulative substrate formed of FR4 or other suitable material. Solder masks overlies each copper coil. A polyimide film is used to insulate each PCB in the stack. Electrically insulative layers formed of FR4 or other suitable material are also provided at the top and bottom of each stack to provide sufficient electrical isolation between the coil and the core. Further specifics of the transformers are described in U.S. Provisional Application No. 63/163,604 filed on Mar. 19, 2021, the relevant portions of which are incorporated herein by reference.

The rectifier is a full-wave rectifier comprising a pair of diode arrays 326a and 326b. Each diode array is electrically connected at one end to a respective terminal 324d, 324e on the secondary side of the boost transformer array 324. The other ends of the diode arrays 326a and 326b are electrically connected to an output DC rail 327a. Each diode array is configured to convert half cycles of the sinusoidal wave received from the secondary side of the boost transformer array 324 into pulsating DC output that is combined on the output DC rail 327a. Each diode array may be a single series diode array comprising one or more diodes or may comprise multiple series diode arrays connected in parallel, again with each series diode array comprising one or more diodes.

In this embodiment, each diode array comprises five (5) diodes that are electrically connected in series. The diodes are selected to have high reverse-bias breakdown, high current capabilities, fast recovery periods, low forward voltage drops, good heat dissipation and good breakdown immunity. As mentioned above, the diode arrays may have more than or less than five diodes. The number of diodes in the diode arrays is limited by the condition that the reverse breakdown voltages of the diode arrays are greater than the boost voltage from the boost transformer array 324. In other words, if diodes with lower reverse breakdown voltages are employed, more diodes are required, and if diodes with higher reverse breakdown voltages are employed, fewer diodes are required. For example, if each diode has a reverse breakdown voltage of 8 kV and the output of the DC to DC boost converter 200 is about 33 kV, five diodes are required. Alternatively, if each diode has a reverse breakdown voltage of 24 kV and the output of the DC to DC boost converter 200 is about 33 kV, two diodes are required. The number of diodes connected in series and/or parallel is a function of the reverse breakdown voltage of the selected diodes and the maximum forward currents the selected diodes permit.

The output filter unit 310 comprises a capacitor bank 329 electrically connected across output DC rail 327a and output DC rail 327b that leads to the negative tap 324c of the boost transformer array 324, a resistor array 330 that is electrically connected across the output DC rails 327a and 327b in parallel with the capacitor bank 329, and an inductor array 328 electrically in series with the output DC rail 327a. Although the capacitor bank 329 is shown as comprising a 4×3 array of capacitors 329a and the resistor array 330 is shown as comprising four (4) resistors 330a in series, this is for ease of illustration only. As will be appreciated by those of skill in the art, the capacitor bank 329 and the resistor array 330 will typically include significantly more capacitors 329a and resistors 330a than shown. The number of capacitors 329a and resistors 330a that are employed is determined, for example, by the type(s) of capacitors selected (polypropylene film, ceramic etc.) used, and the anticipated DC output voltage, the DC output power, DC output stability. Likewise, although the inductor array 328 is shown as comprising a single inductor, again this is for ease of illustration only. As will be appreciated by those of skill in the art, the inductor array 328 will typically include more inductors.

The output filter unit 310 is configured to receive the pulsating DC output from the rectifier and smooth ripples and stabilize the DC output. The output filter unit 310 is further configured to provide the necessary capacity to overcome any instantaneous load fluctuations. The resistor array 330 serves as a bleeder resistor that discharges the capacitor bank 329 slowly when the DC to DC boost converter 200 is turned off. In this embodiment, the resistor array 330 also functions as a voltage divider to thereby ensure that the voltage across each capacitor 329a in the capacitor bank 329 remains the same.

The output unit 312 comprises two output terminals 312a and 312b at the terminal ends of the output DC rails 327a and 327b. The output terminals are readily connectable to the circuit breaker 132.

The system controller 350 generates signals that are applied to the gate drivers 322 to control switching of the power transistors 320. In order to maintain a stable output of the DC to DC boost converter 200, the system controller 350 gathers feedback data, primarily the input current and voltage and the output current and voltage, from the input filter unit 304 and the output unit 312. Other sensor data may be acquired by the system controller 350, such as temperature, auxiliary voltage, local power supply voltages, etc.

When the input terminals 302a and 302b are connected to the associated solar panel string 122 and an input DC voltage appears across the input DC rails 303a and 303b, the input DC voltage is filtered and stabilized by the input filter unit 314, which attenuates unwanted harmonics before the input DC voltage appears at the bridge converter unit 306. At the bridge converter unit 306, the input DC voltage is converted to an AC sinusoidal wave. This is achieved by signaling the gate drivers 322 via the system controller 350 causing the gate drivers to turn selected pairs of the power transistors 320 on and off at a frequency in the range of from about 100 kHz to about 500 kHz.

The output AC sinusoidal wave of the bridge converter unit 306 is applied to the primary side of the boost transformer array 324 which in turn generates a stepped up AC sinusoidal wave that appears on the secondary side of the boost transformer array 324. The rectifier 326 then converts the stepped up sinusoidal wave to pulsating DC output that is applied to the output filter unit 310. The output filter unit 310 smooths the pulsating DC signal to remove rippling as well as stabilizes the DC output so that a stable boosted DC voltage appears across the output terminals 312a and 312b.

As mentioned above, the DC to DC boost converter 200 may be used standalone to boost input DC from a lower voltage to a higher voltage. The DC to DC boost converter may however, be used in series with other similar DC to DC boost converters to enable higher DC output voltages to be achieved, in parallel with other DC to DC boost converters to enable higher DC output currents to be achieved, or in series-parallel combinations with other DC to DC boost converters to enable both higher DC output voltages and higher DC output currents to be achieved. This allows the DC to DC boost converters to be combined as needed to suit individual DC generating stations, thus removing the need for a custom solution for each new DC generating station project. Furthermore, any upsizing of an existing DC generating station, such as the addition of new solar panel arrays to an existing solar farm, or addition of new battery storage units to an existing storage system, only requires the addition of DC to DC boost converters in order to support the increased power generation of the DC generating station.

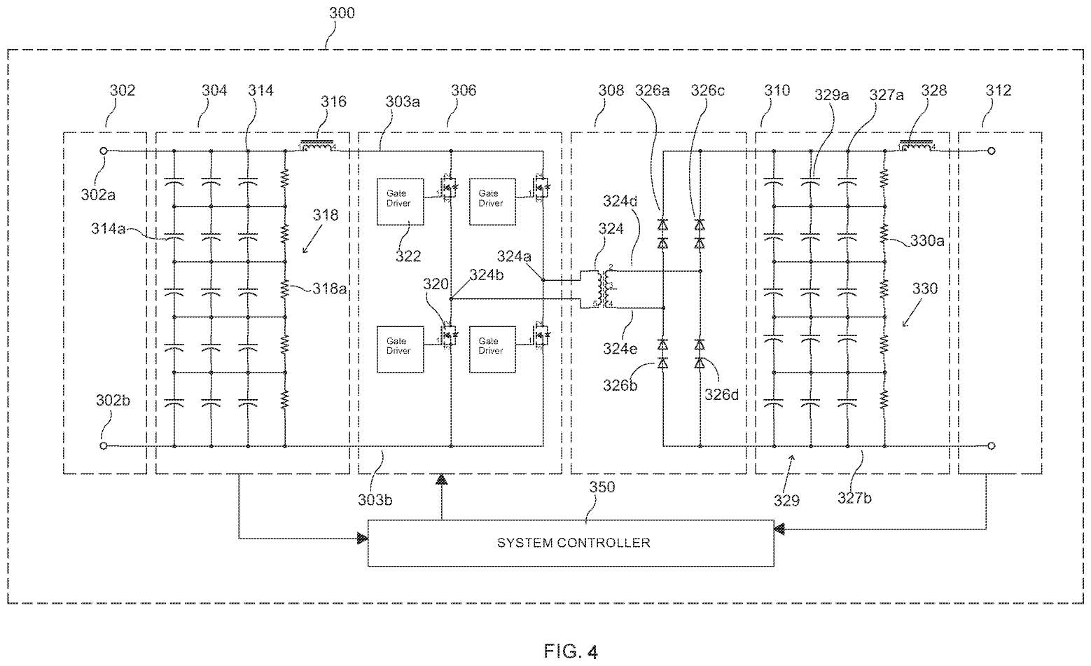

Although the DC to DC boost converter 300 has been described above as employing a negative-tapped boost transformer array, alternatives are available. For example, the negative-tapped boost transformer array may be replaced with a regular boost transformer array as shown in FIG. 4. For ease of illustration, in FIG. 4 like reference numbers will be used to indicate like components. As can be seen, in this embodiment, the boost transformer array 324 has no negative tap. The rectifier is a full-bridge rectifier comprising four (4) diode arrays 326a, 326b, 326c, and 326d. Each diode array is shown as comprising two (2) diodes electrically connected in series. Diode arrays 326a and 326 are electrically connected in a series arrangement across the output DC rails 327a and 327b. Diode arrays 326c and 326d are electrically connected in a series arrangement across the output DC rails 327a and 327b in parallel with the diode arrays 326a and 326b. At the secondary side of the boost transformer array 324, terminal 324d is connected to the series arrangement of the diode arrays 326c and 326d at a point between the diode arrays 326c and 326d and terminal 324e is connected to the series arrangement of the diode arrays 326a and 326b at a point between the diode arrays 326a and 326b. The diode arrays are configured to convert cycles of the AC sinusoidal wave received from the secondary side of the boost transformer array 324 into pulsating DC output that is combined on the output DC rail 327a.

Similar to the previous embodiment, the diodes are selected to have high reverse-bias breakdown, high current capabilities, fast recovery periods, low forward voltage drops, good heat dissipation and good breakdown immunity. The number of diodes in the diode arrays is limited by the condition that the reverse breakdown voltages of the diode arrays are greater than the boost voltage from the boost transformer array 324. In other words, if diodes with lower reverse breakdown voltages are employed, more diodes are required, and if diodes with higher reverse breakdown voltages are employed, fewer diodes are required.

Although in the embodiment described above the power transmission system is described as comprising a DC generating station in the form of a solar power farm, those skilled in the art will appreciate that alternatives are available. For example, the DC generating station may be a battery energy storage system, or other source of power that produces low voltage DC output such as, but not limited to, a hydrogen fuel cell power plant, steam turbines coupled to DC generators, and magnetohydrodynamic (MHD) generators.

As will be appreciated, by providing a direct DC to DC step up solution that boosts generated low voltage DC up to the required voltage level for transmission over the MVDC or HVDC transmission line, fewer intermediate stages are required thereby reducing complexity and implementation and maintenance costs. Also, the need for substations at the DC generating stations, that require custom designed transformers and static VAR compensators, are avoided.

Although embodiments have been described above with reference to the drawings, those of skill in the art will appreciate that other variations and modifications may be made.

What is claimed is:

1. A power transmission method comprising:
receiving direct current (DC) input from a generating station;
boosting the voltage of the DC input to a higher transmission voltage; and
transmitting the boosted DC over a medium voltage (MV) or high voltage (HV) DC transmission line to a destined load.

2. The power transmission method of claim 1, further comprising, after transmission over the DC transmission line, converting the boosted DC to alternating current (AC) output for feeding to the destined load.

3. The power transmission method of claim 1, wherein the received DC input is in the range of about 600V to about 1200V.

4. The power transmission method of claim 3, wherein the DC input is boosted to a voltage in the range of about 33 kV to about 230 kV.

5. The power transmission method of claim 4, wherein the DC input is received from one of a solar power farm, a battery energy storage system, a hydrogen fuel cell plant, one or more DC generators, and one or more magnetohydrodynamic generators.

6. The power transmission method of claim 1, wherein the boosting is performed by a DC to DC boost converter or an array of DC to DC boost converters.

7. The power transmission method of claim 6, wherein the boosting comprises:
converting the DC input to alternating current (AC) output;
stepping up the AC output; and
rectifying the stepped-up AC output to generate the boosted DC.

8. A power transmission system comprising:
at least one DC to DC boost converter configured to receive and boost a DC input received from a DC generating station; and
an MVDC or HVDC transmission line electrically connected to the at least one DC to DC boost converter and configured to transmit the boosted DC input to a destined load.

9. The power transmission system of claim 8, comprising a plurality of DC to DC boost converters, each receiving a DC input from the DC generating station and providing boosted DC input to the transmission line.

10. The power transmission system of claim 9, wherein the plurality of DC to DC converters comprises one of (i) DC to DC converters connected electrically in parallel, (ii) DC to DC converters electrically connected in series, and (iii) DC to DC converters electrically connected in parallel and in series.

11. The power transmission system of claim 10, wherein the DC generating station is a solar power farm and each DC to DC converter is configured to receive DC input from one or more respective solar panel strings of the solar power farm.

12. The power transmission system of claim 8, wherein the DC input is in the range of about 600V to about 1200V.

13. The power transmission system of claim 12, wherein the DC input is boosted to a voltage in the range of about 33 kV to about 230 kV.
